(19) United States
(12) Patent Application Publication
(10) Pub. No.: US 2020/0366239 A1
(43) Pub. Date: Nov. 19, 2020

(54) AMBIENT HEAT COLLECTION PANEL

(71) Applicants: Alastair Gordon Laurence Hunter, Isle of Wight (GB); Arron Grist, Isle of Wight (GB)

(72) Inventors: Alastair Gordon Laurence Hunter, Isle of Wight (GB); Arron Grist, Isle of Wight (GB)

(21) Appl. No.: 15/932,373

(22) PCT Filed: Aug. 19, 2016
(86) PCT No.: PCT/GB2016/052574

§ 371 Date: Feb. 17, 2018

(30) Foreign Application Priority Data
Aug. 19, 2015 (GB) 1514722.6

(51) Int. Cl. H02S 40/44; F24S 10/50; H02S 40/36

(52) U.S. Cl. CPC H02S 40/44; F24S 2020/13; H02S 40/36; F24S 10/502

(57) ABSTRACT

An ambient heat collection panel (2) comprising an outer surface (4), an inner surface (6) opposite the outer surface (4), substantially parallel internal ducts (12,14) between the outer and inner surfaces and for defining flow and return paths for a heat transfer fluid and a photo-voltaic module (18) attached to the outer surface (4).

This invention relates to ambient heat collection panels.

Such panels may be used as tiles and/or cladding on buildings in order to collect energy from the ambient atmosphere and, when available, from the direct rays of the sun.

Such an ambient heat collection panel is described in our previous European Patent EP0775283B.

According to the present invention, there is provided an ambient heat collection panel comprising an outer surface, an inner surface opposite the outer surface, substantially parallel internal ducts between the outer and inner surfaces and for defining flow and return paths for a heat transfer fluid and a photo-voltaic module attached to the outer surface.

Owing to this aspect, collection of energy from environmental solar energy by way of both solar photo-voltaic and solar thermal can be achieved.

Preferably, the panel is an interlocking extruded liquid filled ‘tile plank’ for forming a roof surface.

Advantageously, the panel further comprises a recess in the outer surface for receiving the photo-voltaic module therein. The photo-voltaic module is advantageously secured into the recess formed in the outer surface of the panel by any suitable means.

The panel is preferably an aluminium alloy extrusion, anodised in order to provide electrical isolation and corrosion resistance. Moreover, the aluminium alloy is advantageously treated with Plasma Electrolytic Oxidation, also known as microarc oxidation, in order to provide electrical isolation and corrosion resistance.

Totally enclosed cable ducts within the body of the aluminium extrusion provide mechanical and weather protection to interconnection cables related to the photo-voltaic module.

The photo-voltaic module is pre-wired with connections contained in a covered section at the outer end region(s) of the panel.

The photo-voltaic module is preferably pre-wired with multiple modules contained in one extrusion. This gives redundancy in the event of partial shadow.

The fluid-filled ducts are interconnected to form a continuous fluid circuit. This circuit delivers the heat collected to thermal stores for use by other processes.

An embodiment of the invention will now be described, by way of example only, with reference to the accompanying drawings, in which:

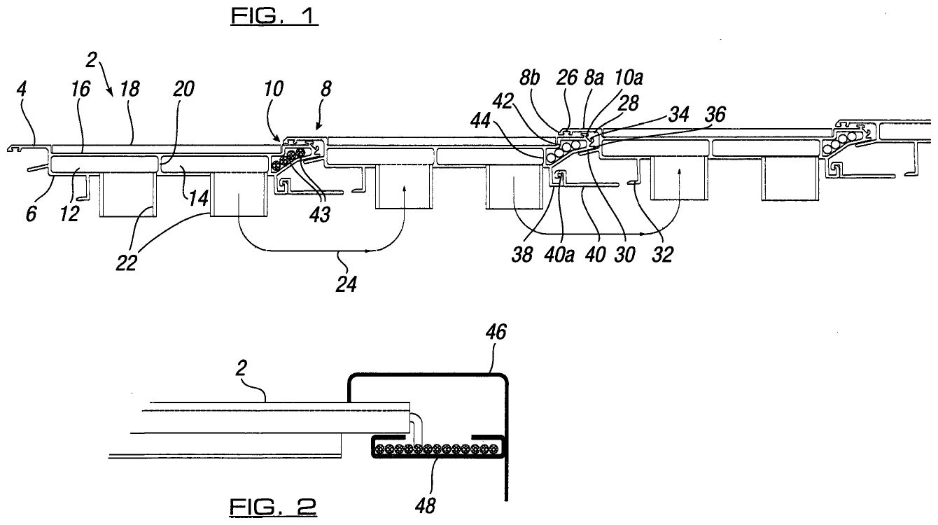

FIG. 1 is a fragmentary side view of a roof structure of a building, and

FIG. 2 is a fragmentary partial sectional view of an outer edge region of the roof structure showing a covered cable tray.

Referring to FIG. 1, a building such as a house having a pitched roof structure may be clad with a plurality of solar energy collection panels 2, mounted on existing roof rafters. The panels 2 are disposed in an edge-overlapping relationship.

Each panel 2 comprises an outer surface 4, an inner surface 6 opposite the outer surface 4 and is in the form of a plank-like aluminium alloy extrusion of substantial length, preferably to cover the entire width of the roof structure to which the panel 2 is being placed upon, and of rectangular plan form, having longitudinal complimentary edge-coupling portions 8 and 10.

Each elongate panel 2 is formed with a pair of substantially parallel internal ducts 12 and 14 disposed side-by-side. The ducts 12 and 14 define flow and return paths respectively for a heat transfer fluid, which may be, for example, water. Advantageously, the water contains antifreeze and corrosion inhibitors.

Each panel 2 is further provided with a recess 16 in the outer surface 4 for receiving a photo-voltaic module 18 therein. The depth of the recess 16 preferably is substantially the same as the depth of the module 18 to be secured therein such that the upper surface of the module 18 is substantially flush with the outer surface 4. The or each module 18 uses light energy from the sun to generate electricity. The module 18 is advantageously secured into the recess 16 by any suitable means, such as bonding. The module 18 is preferably pre-wired with multiple modules 18 contained in one recess 16 in order that there is continued operation in the event of a partial shadow over the roof structure, in which case bypass diodes may be incorporated into the arrangement in order to maximise the output of the modules 18 still illuminated.

The plurality of panels 2 are disposed in rows on the rafters, each panel extending longitudinally across the entire width of the roof structure.

The flow and return ducts 12 and 14 are divided from each other by an integral barrier wall 20 and the return duct 14 of one panel 2 is connected to the flow duct 12 of a neighbouring panel 2 by way of ports 22 which can be connected with a suitable length of tubing, or the like as shown in FIG. 1 by the flow direction 24.

The operation of energy collection by way of the flow of the heat transfer fluid through the ducts 12 and 14 is as described in our previous European Patent EP0775283.

In a similar way to that described in EP0775283, the edge-coupling portion 8 is formed with an outwardly projecting lateral extension 8a terminating in an enlarged head 8b defining a longitudinal groove 26. The groove 26 may locate a flexible weather-sealing strip (not shown).

The portion 8 is also formed with a longitudinal recess 28 having a bottom landing 30, as well as a longitudinally-extending foot 32 which rests on a rafter (not shown).

The edge-coupling portion 10 is formed with an outwardly projecting extension 10a formed with a longitudinally-extending groove 34 which also may locate a flexible weather-sealing strip (not shown). The portion 10 is also formed with an outwardly-projecting ledge 36 which rests on the landing 30 of the edge-coupling portion 8 of the adjacent panel 2.

The edge-coupling portion 10 is also formed with a projection 38, which is substantially L-shaped. This projection 38 is arranged to receive, at longitudinally-spaced intervals, panel fixing clips 40 having hook-like end regions 40a which engage with the projection 38. The clips 40 are secured to the rafters by way of battens and nails.

The edge-coupling portion 10 comprises a totally enclosed cable conduit 42 to house interconnection cables 43 associated with the module 18. The conduit 42 is separated from the return flow duct 14 by a further integral wall 44 and provides mechanical and weather protection to such cables.

It can be seen therefore that the panels 2 are arranged on each side of the roof structure in an overlapping relationship; an edge portion 8 of one panel 2 is received by the edge portion 10 of the adjacent panel 2, so that adjacent panels 2 inter-engage at their longitudinal edges.

Thus heat from the ambient atmosphere is collected by the panels 2, in particular the outer surfaces 4 thereof, and is transferred to the fluid flowing through the internal ducts 12 and 14. The heat is subsequently transferred to a heat sink and/or radiators disposed in the building.

The fluid-filled ducts 12 and 14 are located beneath the recess 16 in which the module 18 is secured and are interconnected as aforesaid to form a continuous fluid circuit. This fluid circuit delivers the heat collected to thermal stores for use by other processes.

Use of a blocking diode in the module circuit prevents reverse current damaging a module when a shadow has isolated generation whilst other modules are still active. Each blocking diode may be arranged to be housed and/or bonded to the inner surface 6 by suitable means adjacent/below the fluid flow ducts 12 and 14 in order to provide cooling of the blocking diodes in a similar manner to that of the cooling provided for the module 18.

Referring to FIG. 2, the photo-voltaic module 18 is pre-wired prior to installation. The cables emanating from the outer end regions of the panels 2 are covered by a cover 46 with the cables themselves being housed in a cable tray 48 within the cover 46. The cover 46 and cable tray 48 provides mechanical and weather protection.

The panels 2 thus utilise the two principal methods for collecting energy from environmental solar energy, solar photo-voltaic and solar thermal. The two technologies are complimentary in that solar photo-voltaic collection uses light energy with a wavelength 1,100 nanometres (nm), corresponding to short wave infra-red light, and solar thermal collection makes use of the remainder of the light spectrum and can convert this to heat energy.

Energy from light at 1,100 nm has just enough energy to knock free an electron in a silicon atom, the most commonly used semiconductor material and thereby generate a flow of electricity. The bandwidth used is small. The longer wavelengths either pass straight through or are absorbed as heat. Shorter wavelengths are also lost as heat as they have more energy than required to excite the electron change. These factors combine to produce a theoretical upper limit to photo-voltaic efficiency of around 31%.

It is also recognised that elevated operating temperatures have an impact on photo-voltaic efficiencies. The water filled ducts 12 and 14 also provide cooling for the modules 18. The delivery of heat energy collected to thermal stores in the continuous fluid circuit thereby results in cooling and improving the efficiency of the modules 18.

Owing to the fact that the panels 2 are of an extruded product, they may assume different forms.

A building could be wholly or partially clad by the panels 2.

The interlocking panels 2 ensure that the roof finish is free from penetrations, they form a continuous weather-tight finish and they maximise the energy collection from the available roof space.

It is also possible to enable the panels 2 to interlock with the panels described in our previous European Patent EP0775283. This gives the ability to add in a variable quantity of panels 2 in conjunction with the project requirements.

The panels 2 are relatively fast to fix, the integration is carried out off-site, the panels 2 are installed by a standard fixing method using existing tile clips, and the panels 2 fix directly to existing rafters without the need for a vapour barrier or roof felt. Insulation can be applied to inner surface after installation, for example, by being sprayed in situ.

Compared to conventional roof tiles, there is with the panels 2 only a relatively small number of elements to be installed with just a few interconnections to be made on-site, thus improving installation time and reliability.

The photo-voltaic panel 2 also forms a building element (e.g. a roof element or a cladding element) thereby saving costs in terms of both materials and labour.

Roof wind loadings are also reduced compared to conventionally mounted photo-voltaic panels which require an air gap for ventilation behind the photo-voltaic panels.

The aesthetics are also significantly improved with the panels 2 providing a clean, uncluttered finish.

Combining the two energy collection technologies has the following primary benefits:
maximum use is made of a given aperture
the efficiency of the photo-voltaic module 18 is improved by the introduction of cooling.
manufacturing costs are reduced by the use of common elements.
installation costs are reduced
heat generated in the photo-voltaic module 18 can be utilised.

1. An ambient heat collection panel comprising an outer surface, an inner surface opposite the outer surface, substantially parallel internal ducts between the outer and inner surfaces and for defining flow and return paths for a heat transfer fluid and a photo-voltaic module attached to the outer surface.

2. A panel according to claim 1, and further comprising a recess in the outer surface for receiving the photo-voltaic module therein.

3. A panel according to claim 2, wherein the photo-voltaic module is secured into the recess.

4. A panel according to claim 1, and further comprising complimentary first and second edge-coupling portions, the first edge coupling portion of one panel being received into the second edge coupling portion of an adjacent panel to form an overlapping connection between adjacent panels.

5. A panel according to claim 4, wherein the second edge-coupling portion comprises an enclosed cable conduit to house interconnection cables associated with the module.

6. A panel according to claim 1, and further comprising a cover at the outer end region(s) of the panel.

7. A panel according to claim 5, wherein the cover houses a cable tray for carrying cables associated with the module.

8. A panel according to claim 2, wherein the recess receives a plurality of modules.

9. A panel according to claim 2, wherein the ducts are located beneath the recess containing the module.

10. A panel according to claim 1, and further comprising means located on the inner surface to house a blocking diode.

11. An energy collection system comprising a plurality of panels according to claim 1.

12. A building clad, at least partially, by a plurality of panels according to claim 1.

13. A building including a system according to claim 11.
